(19) United States
(12) Patent Application Publication
(10) Pub. No.: US 2009/0326111 A1
(43) Pub. Date: Dec. 31, 2009

(54) Impact resistant, flame retardant thermoplastic molding composition

(75) Inventor: Marina Rogunova, Pittsburgh, PA (US)

Correspondence Address: BAYER MATERIAL SCIENCE LLC, 100 BAYER ROAD, PITTSBURGH, PA, 15205, US

(73) Assignee: Bayer MaterialScience LLC

(21) Appl. No.: 12/215,790

(22) Filed: Jun. 30, 2008

(51) Int. Cl. C08K 5/526

(52) U.S. Cl. 524/127

(57) ABSTRACT

A thermoplastic molding composition characterized by its flame retardance and impact strength is disclosed. The composition contains (A) linear aromatic (co)polycarbonate, (B) a graft (co)polymer having a grafted phase containing the polymerization product of at least one vinyl monomer and a substrate in particulate form that contains crosslinked member selected from the group consisting of (i) rubber containing interpenetrated and inseparable silicone and poly(meth)alkyl acrylate components and (ii) silicone rubber, (C) a phosphorous-containing flame retardant compound, (D) fluorinated polyolefin. The composition containing neither polyalkylene terephthalate nor boron compounds.

### FIELD OF THE INVENTION

The invention relates to thermoplastic molding compositions and in particular to impact-modified, flame retardant thermoplastic molding compositions that contain aromatic polycarbonate resin.

### TECHNICAL BACKGROUND OF THE INVENTION

Impact-modified blends of polycarbonate are known. Also known are flame resistant polycarbonate compositions where the flame retarding agent is a phosphorous compound, most notably oligomeric organic phosphoric or phosphonic acid esters. An impact modified thermoplastic molding composition containing polycarbonate and a graft (co)polymer wherein the graft base includes a rubber selected from a group that includes silicone-acrylate composite has been disclosed in U.S. Pat. No. 7,067,567. This graft (co)polymer is exemplified by methyl methacrylate-grafted silicone-butyl acrylate composite rubber.

An impact resistant composition containing polycarbonate and graft polymer based on a silicone-butyl acrylate composite rubber is disclosed in U.S. Pat. No. 4,888,388. A flame retardant, chemically resistant and thermally stable composition containing a halogenated aromatic polycarbonate resin, aromatic polyester resin, and graft rubber polymer composite is disclosed in JP 04 345 657. The graft rubber is said to be obtained by grafting vinyl monomer(s) onto rubber particles consisting of a poly-organosiloxane rubber and a polyalkyl (meth)acrylate rubber entangled so as not to be separated from each other. JP8259791 disclosed a flame-retardant resin composition said to feature excellent impact resistance and flame retardance and containing polycarbonate resin with a phosphoric ester compound and a specific composite-rubber-based graft copolymer. The composite-rubber-based graft copolymer is obtained by grafting at least one vinyl monomer (e.g. methyl methacrylate) onto a composite rubber that contains 30-99% polyorganosiloxane component and 70-1% of polyalkyl(meth)acrylate rubber component. JP 7316409 disclosed a composition having good impact resistance and flame retardance containing polycarbonate, phosphoric ester and a specified graft copolymer based on a composite rubber. The graft copolymer is obtained by graft polymerization of one or more vinyl monomers onto a composite rubber in which polyorganosiloxane component and polyalkyl(meth)acrylate rubber component are entangled together so as not to be separable.

U.S. Pat. No. 6,423,766 disclosed a flame-retardant polycarbonate resin composition, containing polycarbonate resin, a composite rubbery graft copolymer, a halogen-free phosphoric ester and polytetrafluoroethylene. The composition is said to exhibit improved mechanical properties, moldability, flowability, and flame retardance. The graft rubber is based on polyorganosiloxane rubber component and polyalkyl acrylate rubber component and the two components are inter-twisted and inseparable from each other. The grafted rubber is grafted with one or more vinyl monomers.

Currently pending patent applications Ser. No. 11/713352 filed Mar. 2, 2007 and Ser. No. 12/012,947 filed Feb. 6, 2008, both assigned to the assignee of this application disclosed compositions containing presently relevant components.

### SUMMARY OF THE INVENTION

A thermoplastic molding composition free of polyalkylene terephthalate and boron compounds, characterized by its flame retardance and impact strength is disclosed. The composition contains (A) linear aromatic (co)polycarbonate, (B) a graft (co)polymer in which the grafted phase contains polymerized vinyl monomers and in which the substrate contains a crosslinked member in particulate form selected from the group consisting of (i) silicone(meth)acrylate rubber and (ii) polysilicone rubber (C) a phosphorous-containing flame retardant compound and (D) fluorinated polyolefin. Thin-walled articles molded of the composition are characterized by superior flame resistance. The composition is further characterized in that it contains neither polyalkylene terephthalate not boron compounds.

### DETAILED DESCRIPTION OF THE INVENTION

The inventive composition that features exceptional flame retardance and impact strength contains
A) 50 to 95 percent by weight (pbw), preferably 65 to 90 pbw, most preferably 70 to 85 pbw of linear aromatic (co)polycarbonate, preferably having a weight-average molecular weight of at least 25,000 more preferably at least 26,000 g/mol.,
B) 1 to 15 preferably 3 to 12, more preferably 5 to 8 pbw of a graft (co)polymer, in which the grafted phase contains polymerized vinyl monomer and in which the substrate contains a crosslinked member in particulate form selected from the group consisting of (i) silicone (meth)acrylate rubber and (ii) polysilicone rubber, and
C) 2 to 20, preferably 5 to 15, particularly preferably 7 to 15, most preferably 10 to 13 pbw of a phosphorus-containing compound, preferably organic phosphoric or phosphonic acid ester, and
D) 0.1 to 2, preferably 0.2 to 1, most preferably 0.2 to 0.5 pbw of fluorinated polyolefin.
   The composition contains neither polyalkylene terephthalate no any boron compound.

Any numerical range recited herein is intended to include all sub-ranges subsumed therein.

### Component A

Suitable linear aromatic (co)polycarbonates (including linear aromatic polyestercarbonates) are known. Such (co)polycarbonates may be prepared by known processes (see for instance Schnell's “Chemistry and Physics of Polycarbonates”, lnterscience Publishers, 1964) and are widely available in commerce, for instance Makrolon® polycarbonate a product of Bayer MaterialScience.

Aromatic polycarbonates may be prepared by the known melt process or the phase boundary process.

Aromatic dihydroxy compounds suitable for the preparation of aromatic polycarbonates and/or aromatic polyester carbonates conform to formula (I)

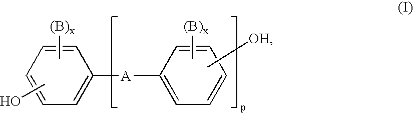

wherein
A represents a single bond, C₁- to C₅-alkylene, C₂- to C₅-alkylidene, C₅- to C₆-cycloalkylidene, —O—, —SO—, —CO—, —S—, —SO2—, C₆- to C₁₂-arylene, to which there may be condensed other aromatic rings optionally containing hetero atoms, or a radical conforming to formula (II) or (III)

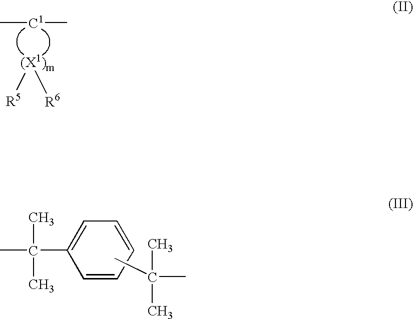

The substituents B independently one of the others denote C₁- to C₁₂-alkyl, preferably methyl,
x independently one of the others denote 0, 1 or 2,
p represents 1 or 0, and
R⁵ and R⁶ are selected individually for each X¹ and each independently of the other denote hydrogen or C₁- to C₆-alkyl, preferably hydrogen, methyl or ethyl,
X¹ represents carbon, and m represents an integer of 4 to 7, preferably 4 or 5, with the proviso that on at least one atom X¹, R⁵ and R⁶ are both alkyl groups.

Preferred aromatic dihydroxy compounds are hydroquinone, resorcinol, dihydroxydiphenols, bis-(hydroxyphenyl)-C₁-C₅-alkanes, bis-(hydroxyphenyl)-C₅-C₆-cycloalkanes, bis-(hydroxyphenyl)ethers, bis-(hydroxyphenyl)sulfoxides, bis-(hydroxyphenyl)ketones, bis-(hydroxyphenyl)-sulfones and α,α-bis-(hydroxyphenyl)-diisopropyl benzenes. Particularly preferred aromatic dihydroxy compounds are 4,4′-dihydroxydiphenyl, bisphenol A, 2,4-bis-(4-hydroxyphenyl)-2-methylbutane, 1,1-bis-(4-hydroxyphenyl)-cyclohexane, 1,1-bis-(4-hydroxyphenyl)-3,3,5-trimethylcyclohexane, 4,4′-dihydroxydiphenyl sulfide, 4,4′-dihydroxydiphenyl-sulfone. Special preference is given to 2,2-bis-(4-hydroxyphenyl)-propane (bisphenol A). These compounds may be used individually or in the form of any desired mixtures.

Chain terminators suitable for the preparation of thermoplastic aromatic polycarbonates include phenol, p-chlorophenol, p-tert.-butylphenol, as well as long-chained alkylphenols, such as 4-(1,3-tetramethylbutyl)-phenol or monoalkylphenols or dialkylphenols having a total of from 8 to 20 carbon atoms in the alkyl substituents, such as 3,5-di-tert.-butylphenol, p-isooctylphenol, p-tert.-octylphenol, p-dodecylphenol and 2-(3,5-dimethylheptyl)-phenol and 4-(3,5-dimethylheptyl)-phenol. The amount of chain terminators to be used is generally 0.5 to 10% based on the total molar amount of the aromatic dihydroxy compounds used. The suitable linear (co)polycarbonates include polyestercarbonates, including such as are disclosed in U.S. Pat. Nos. 4,334,053: 6,566,428 and in CA 1173998 all incorporated herein by reference. Aromatic dicarboxylic acid dihalides for the preparation of the suitable aromatic polyestercarbonates include diacid dichlorides of isophthalic acid, terephthalic acid, diphenyl ether 4,4′-dicarboxylic acid and naphthalene-2,6-dicarboxylic acid. Particularly preferred are mixtures of diacid dichlorides of isophthalic acid and terephthalic acid in a ratio of from 1:20 to 20:1.

The content of carbonate structural units in the thermoplastic aromatic polyestercarbonates is preferably up to 100 mol. %, especially up to 80 mol. %, particularly preferably up to 50 mol. %, based on the sum of ester groups and carbonate groups. Both the esters and the carbonates contained in the aromatic polyester carbonates may be present in the polycondensation product in the form of blocks or in a randomly distributed manner.

The thermoplastic linear aromatic poly(ester) carbonates preferably have weight-average molecular weights (measured by gel permeation chromatography) of at least 25,000, more preferably at least 26,000. The thermoplastic aromatic poly(ester) carbonates may be used alone or in any desired mixture.

### Component B

Component B is a graft polymer in which the grafted phase (B.1) is 5 to 95 wt. %, preferably 10 to 90 wt. %, of the polymerization product of at least one vinyl monomer grafted on a graft base (substrate) (B.2) that is 95 to 5 wt. %, preferably 90 to 10 wt. %, of a member selected from the group consisting of silicone rubber (B.2.1) and silicone-acrylate rubber (B.2.2), the percents being relative to the weight of B.

The graft polymers B are produced by radical polymerization, for example by emulsion polymerization, suspension polymerization, solution polymerization or melt polymerization, preferably by emulsion polymerization or bulk polymerization.

Suitable monomers for preparing B.1 include vinyl monomers such as vinyl aromatics and/or ring-substituted vinyl aromatics (such as styrene, (X-methylstyrene, p-methylstyrene, p-chlorostyrene), (C₁-C₈)-alkyl methacrylates (such as methyl methacrylate, ethyl methacrylate, 2-ethylhexyl methacrylate, allyl methacrylate), (C₁-C₈)-alkyl acrylates (such as methyl acrylate, ethyl acrylate, n-butyl acrylate, t-butyl acrylate), organic acids (such as acrylic acid, methacrylic acid), and/or vinyl cyanides (such as acrylonitrile and methacrylonitrile), and/or derivatives (such as anhydrides and imides) of unsaturated carboxylic acids (for example, maleic anhydride and N-phenyl maleimide). These vinyl monomers may be used singly or as mixtures of at least two such monomers.

Preferred monomers for preparing B.1 are at least one member selected from the group consisting of styrene, α-methylstyrene, methyl methacrylate, n-butyl acrylate and acrylonitrile. Methyl methacrylate is a particularly preferred monomer for preparing B.1.

The glass transition temperature of the graft base B.2 is lower than 10° C., preferably lower than 0° C., particularly preferably lower than −20° C. The graft base B.2 has a mean particle size (d₅₀ value) 0.05 to 10 μm, preferentially 0.06 to 5 μm, particularly preferably 0.08 to 1 μm.

The mean particle size d₅₀ is that diameter, above and below which 50 wt. %, respectively, of the particles lie; it can be determined by means of ultracentrifuge measurement (W. Scholtan, H. Lange, Kolloid-Z. und Z. Polymere 250 (1972), 782-796).

B.2.1 is at least one silicone rubber with graft-active sites, the method of production of which is described, for example, in U.S. Pat. No. 2,891,920, U.S. Pat. No. 3,294,725, U.S. Pat. No. 4,806,593, U.S. Pat. No. 4,877,831 EP 430 134 and U.S. Pat. No. 4,888,388 all incorporated herein by reference.

The silicone rubber according to B.2.1 is preferably produced by emulsion polymerization, wherein siloxane monomer units, cross-linking or branching agents (IV) and optionally grafting agents (V) are employed.

Dimethylsiloxane or cyclic organosiloxanes with at least 3 ring members, preferentially 3 to 6 ring members, are employed, for example, and preferably, as siloxane-monomer structural units, such as, for example, and preferably, hexamethyl cyclotrisiloxane, octamethyl cyclotetrasiloxane, decamethyl cyclopentasiloxane, dodecamethyl cyclohexasiloxane, trimethyltriphenyl cyclotrisiloxanes, tetramethyltetraphenyl cyclotetrasiloxanes, octaphenyl cyclotetrasiloxane.

The organosiloxane monomers may be employed singly or as mixtures of 2 or more such monomers. The silicone rubber preferably contains not less than 50 wt. %, and particularly preferably not less than 60 wt. %, organosiloxane, relative to the total weight of the silicone-rubber component.

Use is preferentially made of silane-based cross-linking agents with a functionality of 3 or 4, particularly preferably 4, by way of cross-linking or branching agents (IV). The following are preferred trimethoxymethylsilane, triethoxyphenylsilane, tetramethoxysilane, tetraethoxysilane, tetra-n-propoxysilane and tetrabutoxysilane. The cross-linking agent may be employed singly or in a mixture of two or more such agents. Tetraethoxysilane is particularly preferred.

The cross-linking agent is employed in an amount of 0.1 to 40 wt. %, relative to the total weight of the silicone-rubber component. The quantity of cross-linking agent is selected in such a way that the degree of swelling of the silicone rubber, measured in toluene, is 3 and 30, preferably 3 and 25, and particularly preferably 3 and 15. The degree of swelling is defined as the weight ratio of the quantity of toluene that is absorbed by the silicone rubber when it is saturated with toluene at 25° C. to the quantity of silicone rubber in the dried state. The ascertainment of the degree of swelling is described in detail in EP 249 964.

If the degree of swelling is less than 3, i.e. if the content of cross-linking agent is too high, the silicone rubber does not display adequate rubber-like elasticity. If the swelling index is greater than 30, the silicone rubber does not form a domain structure in the matrix polymer and therefore does not enhance impact strength; the effect would then be similar to a simple addition of polydimethylsiloxane.

Tetrafunctional cross-linking agents are preferred over trifunctional cross-linking agents, because the degree of swelling is then easier to control within the limits described above.

Suitable as grafting agents (V) are compounds capable of forming structures conforming to the following formulae:

CH₂═C(R²)—COO—(CH₂)ₚ—SiR¹ₙO_{(3-n)/2} (V-1)

CH₂═CH—SiR¹ₙO_{(3-n)/2} (V-2) or

HS—(CH₂)ₚ—SiR¹ₙO_{(3-n)/2} (V-3)

wherein
R¹ denotes C₁-C₄-alkyl, preferably methyl, ethyl or propyl, or phenyl,
R² denotes hydrogen or methyl,
n is 0, 1 or 2 and
p is a number from 1 to 6.

Acryloyloxysilanes or methacryloyloxysilanes are particularly suitable for forming the aforementioned structure (V-1), and have a high grafting efficiency. As a result, an effective formation of the graft chains is enabled, and the impact strength of the resulting resin composition is favored.

The following are preferred: β-methacryloyloxy-ethyldimethoxymethyl-silane, γ-methacryloyloxy-propylmethoxydimethyl-silane, γ-methacryloyloxy-propyldimethoxymethyl-silane, γ-methacryloyloxy-propyl-trimethoxy-silane, γ-methacryloyloxy-propylethoxydiethyl-silane, γ-methacryloyloxy-propyldiethoxymethyl-silane, δ-methacryloyl-oxy-butyidiethoxymethyl-silane or mixtures thereof.

Grafting agents are used in an amount up to 20%, relative to the total weight of the silicone rubber.

The silicone rubber may be produced by emulsion polymerization, as described in U.S. Pat. No. 2,891,920 and U.S. Pat. No. 3,294,725 incorporated herein by reference. In this case the silicone rubber is obtained in the form of an aqueous latex. For this, a mixture containing organosiloxane, cross-linking agent and optionally grafting agent is mixed, subject to shear, with water, for example by means of a homogenizer, in the presence of an emulsifier based on sulfonic acid, such as, for example, alkylbenzenesulfonic acid or alkylsulfonic acid, whereby the mixture polymerises to form silicone-rubber latex. Particularly suitable is an alkylbenzenesulfonic acid, since it acts not only as an emulsifier but also as a polymerization initiator. In this case a combination of the sulfonic acid with a metal salt of an alkylbenzenesulfonic acid or with a metal salt of an alkylsulfonic acid is favourable, because the polymer is stabilized by this means during the later graft polymerization.

After the polymerization the reaction is terminated by neutralizing the reaction mixture by adding an aqueous alkaline solution, for example an aqueous solution of sodium hydroxide, potassium hydroxide or sodium carbonate.

Also suitable as graft bases B.2 in accordance with the invention are silicone-acrylate rubbers (B.2.2). These are composite rubbers with graft-active sites containing 10-90 wt. % silicone-rubber component and 90 wt. % to 10 wt. % polyalkyl-(meth)acrylate-rubber component, the two components permeating each other in the composite rubber, so that they cannot be substantially separated from one another.

If the proportion of the silicone-rubber component in the composite rubber is too high, the finished resin compositions have inferior surface properties and impaired pigmentability. If, on the other hand, the proportion of the polyalkyl-(meth)acrylate-rubber component in the composite rubber is too high, the impact strength of the composition is adversely influenced.

Silicone-acrylate rubbers are known and are described, for example, in U.S. Pat. No. 5,807,914, EP 430 134 and U.S. Pat. No. 4,888,388 all incorporated herein by reference.

Silicone-rubber components of the silicone-acrylate rubbers according to B.2.2 are those which have already been described under B.2.1.

Suitable polyalkyl-(meth)acrylate-rubber components of the silicone-acrylate rubbers according to B.2.2 may be produced from alkyl methacrylates and/or alkyl acrylates, a cross-linking agent and a grafting agent. Exemplary and preferred alkyl methacrylates and/or alkyl acrylates in this connection are the C₁ to C₈ alkyl esters, for example methyl, ethyl, n-butyl, t-butyl, n-propyl, n-hexyl, n-octyl, n-lauryl and 2-ethylhexyl esters; halogen alkyl esters, preferentially halogen C₁-C₈-alkyl esters, such as chloroethyl acrylate, and also mixtures of these monomers. Particularly preferred is n-butyl acrylate.

Monomers with more than one polymerizable double bond may be employed as cross-linking agents for the polyalkyl-(meth)acrylate-rubber component of the silicone-acrylate rubber. Preferred examples of cross-linking monomers are esters of unsaturated monocarboxylic acids with 3 to 8 C atoms and of unsaturated monohydric alcohols with 3 to 12 C atoms, or of saturated polyols with 2 to 4 OH groups and 2 to 20 C atoms, such as ethylene glycol dimethacrylate, propylene glycol dimethacrylate, 1,3-butylene glycol dimethacrylate and 1,4-butylene glycol dimethacrylate. The cross-linking agents may be used singly or in mixtures of at least two cross-linking agents.

Exemplary and preferred grafting agents are allyl methacrylate, triallyl cyanurate, triallyl isocyanurate or mixtures thereof. Allyl methacrylate may also be employed as cross-linking agent. The grafting agents may be used singly or in mixtures of at least two grafting agents.

The quantity of cross-linking agent and grafting agent is 0.1 wt. % to 20 wt. %, relative to the total weight of the polyalkyl-(meth)acrylate-rubber component of the silicone-acrylate rubber.

The silicone-acrylate rubber is produced in a manner that in a first step the silicone rubber according to B.2.1 is produced in the form of a aqueous latex. This latex is subsequently enriched with the alkyl methacrylates and/or alkyl acrylates, cross-linking agent and grafting agent, and a polymerization is carried out. Preferred is a radically initiated emulsion polymerization, initiated for example by a peroxide initiator, an azo initiator or a redox initiator. Particularly preferred is the use of a redox initiator system, especially a sulfoxylate initiator system produced by combination of iron sulfate, disodium methylenediamine tetraacetate, rongalite and hydroperoxide.

The grafting agent which is used in the production of the silicone rubber results in the polyalkyl-(meth)acrylate-rubber component being covalently bonded to the silicone-rubber component. In the course of polymerization, the two rubber components permeate each other and form the composite rubber which after polymerization no longer separates into its constituents components.

For the production of silicone(-acrylate) graft rubbers B the monomer(s) B.1 is (are) grafted onto the rubber base B.2.

In this connection the polymerization methods that are described, for example, in EP 249 964, EP 430 134 and U.S. Pat. No. 4,888,388 may be employed.

For example, the graft polymerization is undertaken in accordance with the following polymerization method. In a single-stage or multi-stage radically initiated emulsion polymerization the desired vinyl monomers B.1 are grafted onto the graft base which is present in the form of aqueous latex. The grafting efficiency here should be as high as possible, and is preferably at least 10%. The grafting efficiency depends crucially on the grafting agent used. After the polymerization to form the silicone(-acrylate) graft rubber, the aqueous latex is passed into hot water in which metal salts, such as calcium chloride or magnesium sulfate, for example, have previously been dissolved. In the process the silicone(-acrylate) graft rubber coagulates and can subsequently be separated.

Graft polymers suitable as component B) are commercially available. Examples include Metablen® SX 005 a product of Mitsubishi Rayon Co. Ltd.

In a preferred embodiment the graft (co)polymer has a core/shell structure. In that embodiment the shell corresponds compositionally to B.1 and the core corresponds compositionally to B.2

### Component C

Phosphorus-containing compounds suitable in the context of the invention include oligomeric organic phosphoric or phosphonic acid esters conforming structurally to formula (IV)

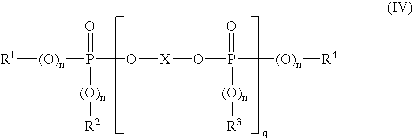

wherein
R¹, R², R³ and R⁴ independently one of the others, each represents C₁- to C₈-alkyl, or C₅-₆-cycloalkyl, C₆-₂₀-aryl or C₇-₁₂-aralkyl each optionally substituted by alkyl, preferably by C₁-₄-alkyl,
n independently one of the others denotes 0 or 1, preferably 1,
q denotes 0.5 to 30, preferably 0.8 to 15, particularly preferably 1 to 5, especially 1 to 2, and
X is a mono- or poly-nuclear aromatic radical having from 6 to 30 carbon atoms, or an aliphatic radical having from 2 to 30 carbon atoms, which may be OH-substituted and may contain up to 8 ether bonds. The aliphatic radical may be linear or branched.

Preferably, R¹, R², R³ and R⁴ each independently of the others represents C₁-₄-alkyl, phenyl, naphthyl or phenyl-C₁-₄-alkyl. In the embodiments where any of R¹, R², R³ and R⁴ is aromatic, it may be substituted by alkyl groups, preferably by C₁-₄-alkyl. Particularly preferred aryl radicals are cresyl, phenyl, xylenyl, propylphenyl or butylphenyl.

In the preferred embodiment X represents a mono- or poly-nuclear aromatic radical having from 6 to 30 carbon atoms. It is preferably derived from any of the aromatic dihydroxy compounds of formula (I).
X particularly preferably represents at least one member selected from the group consisting of

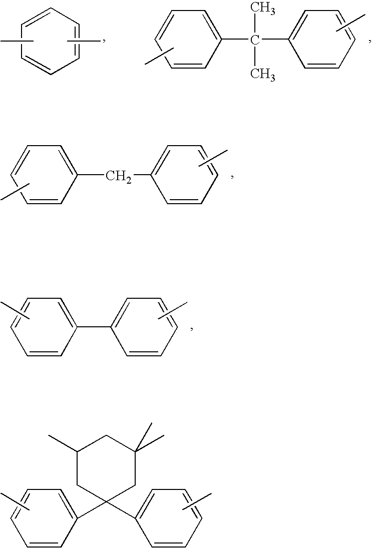

Especially, X may be derived from resorcinol, hydroquinone, bisphenol A or diphenylphenol and particularly preferably from bisphenol A.

Further suitable phosphorus-containing compounds are compounds of formula (IVa)

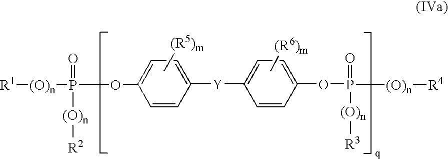

wherein
R¹, R², R³, R4, n and q are as defined for formula (IV),
m independently one of the others represents 0, 1, 2, 3 or 4,
R⁵ and R⁶ independently one of the others represents C₁-₄-alkyl, preferably methyl or ethyl, and
Y represents C₁- to C₇-alkylidene, C₁-₇-alkylene, C₅-₁₂-cycloalkylene, C₅-₁₂-cycloalkylidene, —O—, —S—, —SO₂ or —CO—, preferably isopropylidene or methylene.
   Particularly preferred is

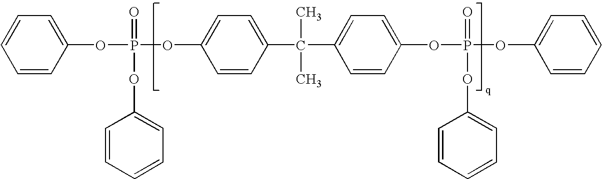

wherein q is 1 to 2.

Such phosphorus compounds are known (see, for example, U.S. Pat. Nos. 5,204,394 and 5,672,645, both incorporated herein by reference) or may be prepared by known methods (e.g. Ullmanns Enzyklopädie der technischen Chemie, Vol. 18, p. 301 etseq. 1979; Houben-Weyl, Methoden der organischen Chemie, Vol. 12/1, p. 43; Beilstein Vol. 6, p. 177).

The phosphorous-containing compound is present in the inventive composition in an amount of 2 to 20, preferably 5 to 15, particularly preferably 7 to 15, most preferably 10 to 13 percent relative to the weight of the composition.

### Component D

Fluorinated polyolefins are known and are described, for example, in U.S. Pat. No. 5,672,645 incorporated herein by reference. They are marketed, for example, under the trademark Teflon.RTM 30N by DuPont. The fluorinated polyolefins may be used in the pure form or in the form of a coagulated mixture of emulsions of the fluorinated polyolefins with emulsions of the graft polymers (component B) or with an emulsion of a copolymer, preferably based on styrene/acrylonitrile, the fluorinated polyolefin being mixed as an emulsion with an emulsion of the graft polymer or of the copolymer and the mixture then being coagulated.

The fluorinated polyolefins may be mixed as powders with a powder or granules of the graft polymer or copolymer and the mixture then compounded in the melt in conventional units, such as internal kneaders, extruders or twin-screw extruders. The fluorinated polyolefins may also be used in the form of a master batch, which is prepared by emulsion polymerization of at least one mono ethylenically unsaturated monomer in the presence of an aqueous dispersion of the fluorinated polyolefin. Preferred monomer components are styrene, acrylonitrile and mixtures thereof. The polymer is employed as a free-flowing powder, after acidic precipitation and subsequent drying.

The coagulates, pre-compounds or master batches conventionally have solids contents of fluorinated polyolefin of 5 to 95 wt. %, preferably 7 to 60 wt. %.

Component D may be contained in the composition according to the invention in an amount of preferably 0.1 to 2, more preferably 0.2 to 1 and most preferably 0.2 to 0.5 percent relative to the total weight of the composition.

### Other Components

The inventive composition may include an optional styrenic copolymer, preferably styrene-acrylonitrile (SAN) at an amount of up to 50, preferably 10 to 30 pbw. The inventive composition may further include effective amounts of any of the additives known for their function in the context of thermoplastic polycarbonate molding compositions. These include one or more of lubricant, mold release agent, for example pentaerythritol tetra-stearate, nucleating agent, antistatic agent, thermal stabilizer, light stabilizer, hydrolytic stabilizer, filler and reinforcing agent, colorant or pigment, as well as further flame retarding agent, other drip suppressant or a flame retarding synergist.

The inventive composition may be produced by conventional procedures using conventional equipment. It may be used to produce moldings of any kind by thermoplastic processes such as injection molding, extrusion and blow molding methods. The Examples which follow are illustrative of the invention.

### EXAMPLES

In the preparation of exemplified compositions, the components and additives were melt compounded in a twin screw extruder ZSK 30 at a temperature profile from 200° C. to 300° C. The pellets obtained were dried in a forced air convection oven at 90° C. for 4 to 6 hours. The parts were injection molded at temperatures equal to or higher than 240° C. and mold temperature of about 75° C.

Each of the exemplified compositions contained:

80.7 percent by weight (pbw) polycarbonate: a bisphenol-A based linear homopolycarbonate having melt flow rate of about 4 g/10 min (at 300° C., 1.2 kg) per ASTM D 1238(Makrolon 3108, a product of Bayer MaterialScience LLC)

12.5 pbw phosphorous compound (designated P-compound): conforming to

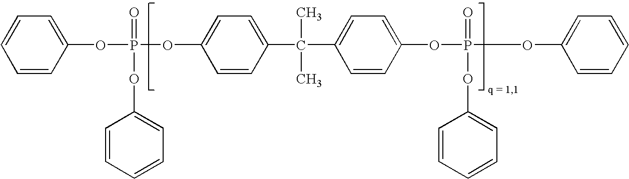

The exemplified compositions contained 0.4 phr fluorinated polyolefin (PTFE) introduced in the form of SAN-encapsulated PTFE in free-flowing powder form, containing 50 pbw PTFE;

Each of the exemplified compositions further included identical amounts, making up the balance 10 100 wt % of small amounts of thermal stabilizer, lubricant and aluminium oxide hydroxide believed to have no criticality in the context of the invention.

The melt flow rates (MFR) of the compositions were determined in accordance with ASTM D-1238 at 240° C., 5 Kg load.

The notched impact strength (NI) was determined at room temperature (about 23° C.) in accordance with ASTM D-256 using specimens ⅛″ in thickness. Failure mode was determined by observation; accordingly “D” means ductile failure.

Instrumental Impact strength was determined at room temperature in accordance with ASTM D3763 using specimens ⅛″.

The flammability rating was determined according to UL-94 on specimens 1.5 mm thick and 0.75 mm thick. Flammability rating in accordance with UL94 5V protocol has also been performed on plaques measuring 6″×6″×2.3 mm thick

The exemplified compositions enable comparison between a graft copolymer of the invention and a graft copolymer that is outside the scope of the present invention. In the inventive composition the graft copolymer was methyl methacrylate (MMA) shell-grafted on to a core of silicone(Si)-butyl acrylate (BA)composite rubber at a weight ratio of Si/BA/MMA of 80/10/10. The graft copolymer of the comparative example is described as: 40 parts by weight of a styrene-acrylonitrile copolymer (S/AN weight ratio of 73/27) grafted phase on a 60 parts by weight particulate, crosslinked polybutadiene emulsion-polymerized rubber. The graft copolymers were present in the respective compositions in an amount of 5 pbw.

TABLE 1

Example

| | 1 | 2 (com.) |
|---|---|---|
| MFR, g/10 min | 10.3 | 11 |
| Impact Strength, | 15.4 | 12.8 |
| notched Izod@23° C., | | |
| ⅛″, ft-lb/in | | |
| Instrumental Impact | 43.1D^{(a)} | 45.4D^{(a)} |
| strength, ⅛″ @ room | | |
| temperature, Energy | | |
| @total, ft.lb | | |
| Flammability, UL94 @ | V0 | V0 |
| 1.5 mm | | |
| Flammability, UL94 @ | V0 | V0 |
| 0.8 mm | | |
| Flammability, UL | 5A | 5B |
| 5 V @ 2.3 mm | | |

^{(a)}D—indicates ductile break;

Example 1 that represents the invention shows a combination of exceptional flame resistance and impact performance. Example2 (comparative) exhibits inferior flammability rating of molded articles having thin walls (2.3 mm) in accordance with the UL 5V test.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A thermoplastic molding composition comprising
A) 50 to 95 percent linear aromatic (co)polycarbonate
B) 1 to 15 percent graft (co)polymer having grafted phase that contains the polymerization product of at least one vinyl monomer and a substrate that contains a crosslinked member in particulate form selected from the group consisting of (i) rubber containing interpenetrated and inseparable silicone component and poly(meth)acrylate component and (ii) silicone rubber,
C) 2 to 20 percent phosphorous-containing flame retarding compound,
conforming to formula (IV) 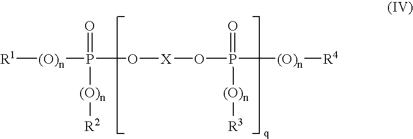
wherein
R¹, R², R³ and R⁴ each independently of the others represents C₁-₈-alkyl, or C₅-₆-cycloalkyl, C₆-₂₀-aryl or C₇-₁₂-aralkyl
n independently one of the others is 0 or 1,
q denotes 0.5 to 30, and
X is a mono- or poly-nuclear aromatic radical having 6 to 30 carbon atoms, or a linear or branched aliphatic radical having 2 to 30 carbon atoms,
and
D) 0.1 to 2 percent fluorinated polyolefin
said percent, all occurrences being relative to the total weight of A), B), C), and D), said composition containing neither polyalkylene terephthalate nor boron compounds.

2. The composition according to claim 1, wherein said A) is present in an amount of 65 to 90 percent, B) is present in an amount of 3 to 12 percent, C) is present in an amount of 5 to 15 percent, and D) is present in an amount of 0.2 to 1 percent .

3. The composition according to claim 1, wherein said A) is a homopolycarbonate based on bisphenol A.

4. The composition of claim 2 wherein said member is rubber containing interpenetrated and inseparable silicone component and poly(meth)acrylate component.

5. The composition of claim 4 wherein said silicone component, poly(methyl)acrylate component and grafted phase relate by weight at a ratio of 70-90/5-15/5-15.

6. The composition of claim 1 wherein said particulate has median particle size of 0.05 to 5 micron.

7. The composition of claim 1, wherein said C) conforms to 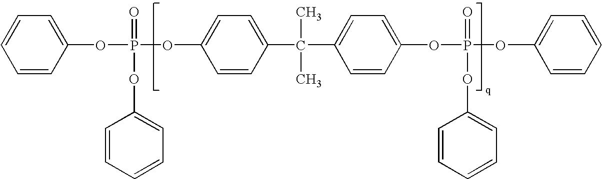
wherein q is 1 to 2.

8. The composition according to claim 1 further containing at least one member selected from the group consisting of styrenic copolymer, lubricant, mold-release agent, nucleating agent, antistatic, thermal stabilizer, hydrolytical stabilizer, light stabilizer, colorant, pigment, filler, reinforcing agent, flameproofing agent other than component C), and flameproofing synergist.

9. The composition of claim 8 wherein said phosphorous-containing flame retardant compound conforms to 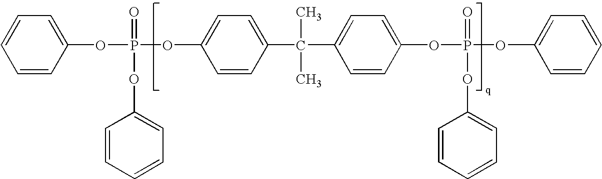
wherein q is 1 to 2.

10. The thermoplastic molding composition of claim 1 wherein said vinyl monomer is selected from the group consisting of styrene, α-methylstyrene, methyl methacrylate, n-butyl acrylate and acrylonitrile.

11. A thermoplastic molding composition comprising
A) 50 to 95 percent linear aromatic (co)polycarbonate
B) 1 to 15 percent graft (co)polymer having a core-shell morphology, in which shell contains polymerized alkyl(meth)acrylate and in which core contains a crosslinked member in particulate form selected from the group consisting of (i) rubber containing interpenetrated and inseparable polyorganosiloxane component and poly(meth)acrylate component and (ii) polysiloxane rubber,
C) 2 to 20 percent phosphorous-containing flame retarding compound conforming to formula (IV) 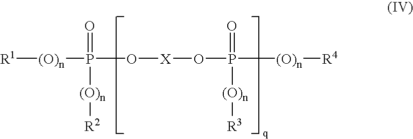
wherein
R¹, R², R³ and R⁴ each independently of the others represents C₁-₈-alkyl, or C₅-₆-cycloalkyl, C₆-₂₀-aryl or C₇-₁₂-aralkyl,
n independently one of the others is 0 or 1,
q denotes 0.5 to 30, and
X is a mono- or poly-nuclear aromatic radical having 6 to 30 carbon atoms, or a linear or branched aliphatic radical having 2 to 30 carbon atoms,
and
D) 0.1 to 2 percent fluorinated polyolefin said percent, all occurrences being relative to the total weight of A), B), C), and D), said composition containing neither polyalkylene terephthalate nor boron compounds.

12. The composition according to claim 11, wherein said A) is present in an amount of 65 to 90 percent, B) is present in an amount of 3 to 12 percent, C) is present in an amount of 5 to 15 percent, and D) is present in an amount of 0.2 to 1 percent.

13. The composition according to claim 11, wherein said A) is a homopolycarbonate based on bisphenol A.

14. The composition of claim 12 wherein said member is rubber containing interpenetrated and inseparable polyorganosiloxane component and poly(meth)acrylate component.

15. The composition of claim 14 wherein said polyorganosiloxane component, poly(methyl)acrylate and shell relate by weight at a ratio of 70-90/5-15/5-15.

16. The composition of claim 15 wherein said ratio is 75-85/7-12/7-12.

17. The composition of claim 16 wherein said ratio is 80/10/10.

18. The composition of claim 11 wherein said particulate has median particle size of 0.05 to 5 micron.

19. The composition of claim 11, wherein said C) conforms to 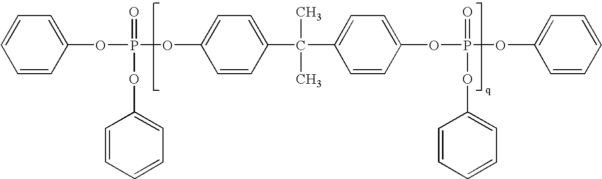
wherein q is 1 to 2.

20. The composition according to claim 11 further containing at least one member selected from the group consisting of styrenic copolymer, lubricant, mold-release agent, nucleating agent, antistatic, thermal stabilizer, hydrolytical stabilizer, light stabilizer, colorant, pigment, filler, reinforcing agent, flameproofing agent other than component C), and flameproofing synergist.
